(19) United States
(12) Patent Application Publication
(10) Pub. No.: US 2020/0057948 A1
(43) Pub. Date: Feb. 20, 2020

(54) AUTOMATIC PREDICTION SYSTEM, AUTOMATIC PREDICTION METHOD AND AUTOMATIC PREDICTION PROGRAM

(71) Applicant: NEC CORPORATION, Tokyo (JP)

(72) Inventors: Ryohei FUJIMAKI, Tokyo (JP); Yukitaka KUSUMURA, Tokyo (JP); Masato ASAHARA, Tokyo (JP); Yusuke MURAOKA, Tokyo (JP)

(73) Assignee: NEC CORPORATION, Tokyo (JP)

(21) Appl. No.: 16/346,004

(22) PCT Filed: Oct. 5, 2017
(86) PCT No.: PCT/JP2017/036364

§ 371 Date: Apr. 29, 2019

(30) Foreign Application Priority Data
Oct. 31, 2016 (JP) 2016-212516

(51) Int. Cl. G06N 5/04; G06F 16/22; G06N 20/00

(52) U.S. Cl. CPC G06N 5/04; G06N 20/00; G06F 16/2282

(57) ABSTRACT

A feature design unit 81 designs, from relational data, a feature as a variable likely to affect an objective variable. A feature generating unit 82 generates the designed feature, from the relational data. A learning unit 83 learns a prediction model, on the basis of the generated feature.

### TECHNICAL FIELD

The present invention relates to an automatic prediction system, an automatic prediction method, and an automatic prediction program that automatically predict a designated subject, on the basis of registered data.

### BACKGROUND ART

There has been commonly performed learning of a prediction model with accumulated data to predict a subject using the learnt prediction model. For example, Patent Literature 1 discloses an example of a method of estimating a mixed model. In the method disclosed in Patent Literature 1, a variational probability of a latent variable for a random variable to be a target of the mixed model estimation of data is calculated. Then, use of the calculated variational probability of the latent variable optimizes the types and parameters of components such that the lower limit of the model posterior probability separated for each component of the mixed model is maximized, thereby estimating the optimized mixed model.

In addition, in recent years, there has been drawing attention the function of a citizen data scientist. The citizen data scientist is, for example, a technician who sufficiently uses business intelligence (BI) tools that automatically generate prediction models. The citizen data scientist applies features and data to be used for prediction to the above-described tools and automatically generates a prediction model to predict a desired subject.

### CITATION LIST

### Patent Literature

PTL 1: International Publication No. 2012/128207

### SUMMARY OF INVENTION

### Technical Problem

In order to effectively utilize the above-described tools, features to be used for prediction need to be appropriately created. Generally, however, such features are often created by an experienced person, and creation of one prediction model requires a long period of time for tuning and the like.

As a result, a so-called citizen data scientist is difficult to appropriately create such features in a short period of time, and also difficult to analyze a prediction model generated on the basis of the created features.

Therefore, an object of the present invention is to provide an automatic prediction system, an automatic prediction method, and an automatic prediction program capable of automatically generate a prediction model with which a desired subject is predicted from existing data, without explicitly designating a feature to be used for prediction.

### Solution to Problem

An automatic prediction system according to the present invention includes: a feature design unit configured to design, from relational data, a feature as a variable likely to affect an objective variable; a feature generating unit configured to generate the designed feature, from the relational data; and a learning unit configured to learn a prediction model, on the basis of the generated feature.

An automatic prediction method according to the present invention includes: designing, from relational data, a feature as a variable likely to affect an objective variable; generating the designed feature from the relational data; and learning a prediction model, on the basis of the generated feature.

An automatic prediction program according to the present invention causes a computer to execute: a feature design process of designing, from relational data, a feature as a variable likely to affect an objective variable; a feature generating process of generating the designed feature, from the relational data; and a learning process of learning a prediction model, on the basis of the generated feature.

### Advantageous Effects of Invention

According to the present invention, there can be automatically generated a prediction model with which a desired subject is predicted from existing data, without explicitly designating a feature to be used for prediction.

### BRIEF DESCRIPTION OF DRAWINGS

FIG. 1 It depicts a block diagram of an exemplary embodiment of an automatic prediction system according to the present invention.

FIG. 2 It depicts an explanatory view of an exemplary screen for accepting information for generating a target table.

FIG. 3 It depicts an explanatory view of an exemplary screen for selecting a plan.

FIG. 4 It depicts an explanatory diagram of an exemplary operation of the automatic prediction system.

FIG. 5 It depicts a flowchart of an exemplary process from automatically designing a feature to performing prediction.

FIG. 6 It depicts a block diagram of the overview of an automatic prediction system according to the present invention.

### DESCRIPTION OF EMBODIMENTS

Hereinafter, an exemplary embodiment of the present invention will be described with reference to the drawings.

### First Exemplary Embodiment

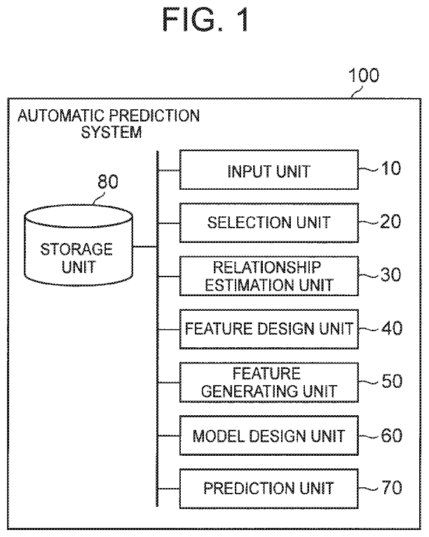

FIG. 1 depicts a block diagram of an exemplary embodiment of an automatic prediction system according to the present invention. An automatic prediction system 100 according to the present exemplary embodiment includes: an input unit 10; a selection unit 20; a relationship estimation unit 30; a feature design unit 40; a feature generating unit 50; a model design unit 60; a prediction unit 70; and a storage unit 80.

The input unit 10 inputs data to be used for model estimation and stores the input data into the storage unit 80. In the present exemplary embodiment, the input unit 10 inputs relational data. The input unit 10 may input information to be received via a communication network (not depicted), or may read and input information from a storage device (not depicted) that stores these pieces of information.

In the following description, when simply described as data, the data represents contents of each cell included in a table representing the relational data, and when described as tabular data, the tabular data represents the entire data included in the table. Each table is defined with a combination of columns representing attributes of the data.

In addition, the input unit 10 may check input data as necessary. In general, a data type to be handled in a relational database is different from a data type to be used in analysis. For example, an ID to be used in analysis is often represented in a type integer (type int) in databases. On the other hand, data input as a type int may be an ID; however, there is also a possibility of a simple integer. Therefore, the input unit 10 may estimate a data type to be analyzed, on the basis of the input data and the type of the input data.

The selection unit 20 selects a subject to be predicted. Specifically, the selection unit 20 generates, from the input data, a table including a column to be predicted (hereinafter referred to as a target table or a first table). For example, the selection unit 20 accepts, from the user, one or more key columns and a column including a variable that is to be predicted (hereinafter referred to as an objective variable) in a table stored in the storage unit 80, and generates a target table.

The subject to be predicted is indicated as an objective variable of a prediction model to be described later. Thus, the variable indicating the subject to be predicted can be referred to as the objective variable. Therefore, it can also be said that the target table is a table containing the objective variable.

The selection unit 20 may also accept, from the user, one or more filter conditions of data to be used as a sample. In addition, the key column corresponds to a column of an aggregation unit to be a target in data aggregation by the feature design unit 40 to be described later.

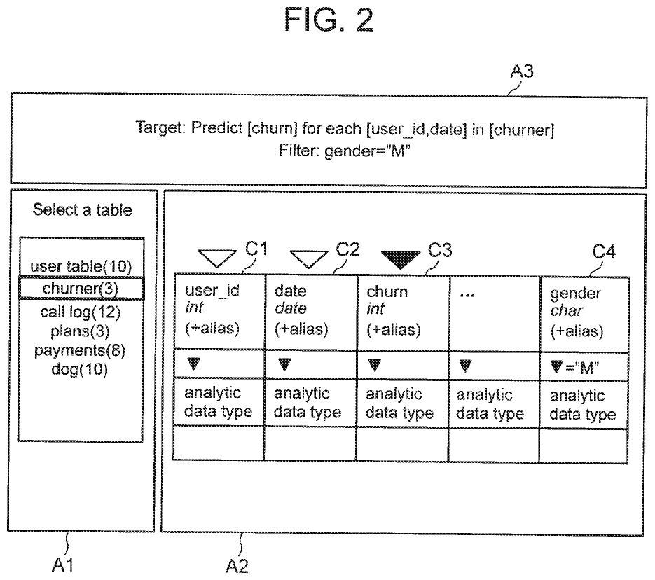

FIG. 2 depicts an explanatory view of an exemplary screen for accepting information for generating a target table. The example depicted in FIG. 2 displays a list of table candidates in an area A1. The user selects a table including a column to be predicted, among the tables displayed in the area A1. The selected table is displayed in an area A2. The example depicted in FIG. 2 indicates that the column of the selected table “churner” includes a type int of a user ID (user_id), a type date of date (date), a type int of large milk-can information (churner), and a type char of gender (gender).

The user selects one or more columns to be regarded as keys, among the respective columns of the table displayed in the area A2. In addition, the user selects a column to be predicted, among the columns of the table displayed in the area A2. The example depicted in FIG. 2 indicates that the user has selected, as the keys, two columns (user_id and date) C1 and C2 each indicated by an open triangle, and a column (churner) C3 indicated by a black triangle as the subject to be predicted.

Each “analytic data type” displayed in the area A2 indicates a data type of data in analysis. In addition, the user designates respective filter conditions of the columns. The example depicted in FIG. 2 indicates that the user has designated data with a value “M”, as the filter condition of the gender column C4.

An area A3 displays the selected information. The selection unit 20 may display the screen exemplified in FIG. 2 and may accept an instruction from the user.

The relationship estimation unit 30 estimates a relationship between columns included in different tables stored in the storage unit 80. For example, the relationship estimation unit 30 may estimate that columns having the same name and same type have a relationship with each other. Note that, in order not to estimate that columns with simplified names have a relationship with each other, the relationship estimation unit 30 may exclude a column having a predetermined name (e.g., “ID”, “date”, “name”, “text”, and “type”), from the candidates.

Furthermore, in order to improve the estimation accuracy, the relationship estimation unit 30 may output an estimation result, and may receive a correction instruction of the user to correct the relationship estimated, on the basis of the correction instruction.

The feature design unit 40 designs a feature to be used for prediction. That is, the feature design unit 40 designs, from the relational data, the feature as a variable likely to affect the objective variable. Specifically, the feature design unit 40 creates a function for generating the feature to be used for prediction (hereinafter referred to as a feature descriptor), on the basis of the input data (relational data) and the designated information.

The feature descriptor is a function for generating a feature from tabular data included in the target table and tabular data of a table different from the target table (hereinafter also referred to as a source table or a second table). Thus, the feature design unit 40 specifies the target table (first table) generated by the selection unit 20 and the source table (second table), and creates the feature descriptor from these specified tables.

The generated feature is a candidate for an explanatory variable in model generation using machine learning. In other words, use of a feature descriptor to be generated in the present exemplary embodiment enables automatic generation of a candidate for an explanatory variable in model generation using machine learning.

The feature descriptor is represented by a plurality of parameters. One such parameter is a parameter representing a correspondence condition of a row of the target table (first table) and a row of the source table (second table) (hereinafter also referred to as correspondence condition element). Furthermore, a parameter representing an aggregation method of aggregating data of each column included in the source table (second table) for each objective variable is another one (hereinafter also referred to as an aggregation method element). The feature design unit 40 generates a combination of the above-described correspondence condition element and aggregation method element to create a feature descriptor.

Examples of parameters for creating a feature descriptor also include a parameter including a conditional expression representing an extraction condition of a row included in the source table (second table) (hereinafter also referred to as an extraction condition element). Therefore, the feature design unit 40 may create a feature descriptor by generating a combination of the above-described correspondence condition element, aggregation method element, and extraction condition element.

The correspondence condition element represents a correspondence condition of a row of the tabular data of the target table (first table) and a row of the tabular data of the source table (second table). Specifically, the correspondence condition element is defined as a pair of columns that associates a column of the target table (first table) with a column of the source table (second table). The correspondence condition element is, for example, a relationship between columns estimated by the relationship estimation unit 30.

The aggregation method element represents an aggregation method of aggregating data of each column included in the source table (second table) for each objective variable. For example, the aggregation method element indicates an aggregation method for each key designated by the selection unit 20. The aggregation method element is defined, for example, as an aggregate function for a column in the source table (second table). The aggregation method is optional, and examples thereof include the sum of columns, the maximum value, the minimum value, the average value, the median value, the variance, and the like. The aggregation method element is predetermined by the user or the like and stored into the storage unit 80.

The extraction condition element represents an extraction condition of a row included in the source table (second table). Specifically, an extraction condition indicated by a first element is defined as a conditional expression for the source table (second table). The extraction condition element is, for example, a filter condition accepted by the selection unit 20.

On the basis of the above-described correspondence condition element, aggregation method element, and extraction condition element, the feature descriptor is defined by, for example, a structural query language (SQL) statement for extracting data from the target table and the source table.

Furthermore, in order to facilitate, for the user, understanding of the contents of the feature created by the feature descriptor, the feature design unit 40 may express the feature descriptor in a natural language. For example, when the feature descriptor is represented by an SQL statement, a template matching an SQL syntax may be prepared in advance, and the feature design unit 40 may apply a column name, a table name, and an extraction condition expressed in a natural language to cites corresponding to the correspondence condition element and extraction condition element of the template. In addition, for use of the aggregation method element, the feature design unit 40 may convert the aggregate function into a natural language expression and may express the aggregate function.

Furthermore, the feature design unit 40 determines a search scale of the feature to be generated by using the created feature descriptor. The search scale of the feature is determined in consideration of computer resources, specifications, time, and prediction accuracy. The feature design unit 40 may present the determined search scale to the user and may accept a search scale desired by the user.

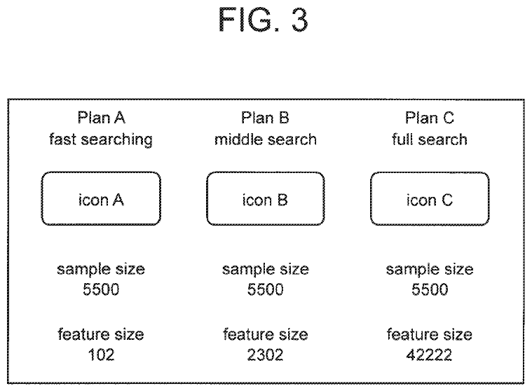

FIG. 3 depicts an explanatory view of an exemplary screen for selecting a plan. The example depicted in FIG. 3 indicates three plans of A to C (fast search, middle, and full search) together with the sizes of samples and features be to a subject for the respective plans.

The feature generating unit 50 generates the feature designed from the relational data. Specifically, the feature generating unit 50 applies the relational data to the created feature descriptor, and generates the feature.

Note that, the feature generating unit 50 may accept designation of a range to be a subject in the target table (specifically, a range of a key to be predicted), and may generate a feature within the range.

The model design unit 60 generates a prediction model, on the basis of the generated feature. Specifically, the model design unit 60 learns the prediction model in which the subject to be predicted is regarded as the objective variable and the generated feature is regarded as the explanatory variable. Note that since the model design unit 60 learns the prediction model, the model design unit 60 can be referred to as a learning unit.

The model design unit 60 subsamples the generated feature. The method of subsampling is optional, for example, a method of randomly selecting a feature (random sampling) can be included. In addition, one or more methods of learning the prediction model are set, and parameters required for each learning are also set. The method of learning the prediction model is optional, and the model design unit 60, for example, may learn the model using the method disclosed in Patent Literature 1.

Furthermore, the model design unit 60 determines the number of subsamples according to a learning scale of the prediction model, the types of algorithms to be used for the learning, and the types of parameters to be set for each algorithm. The learning scale is determined in accordance with computer resources, specifications, time, and the like. The model design unit 60 may calculate several candidates (e.g., small, medium, and large) for the learning scale to present the candidates to the user, and may accept a learning scale desired by the user.

The model design unit 60 generates a prediction model for each of the determined number of subsamples, algorithms, and parameters. Then, the model design unit 60 evaluates (performs evaluation of) the generated prediction model. The evaluation method is optional. For example, the model design unit 60 may evaluate the prediction model using a predetermined evaluation method, or may evaluate the prediction model using an evaluation method selected by the user. Then, the model design unit 60 generates, as a prediction model, an ensemble model obtained with a combination of prediction models with higher evaluation values.

The prediction unit 70 uses the generated prediction model and the feature to predict the subject indicated by the objective variable.

The input unit 10, the selection unit 20, the relationship estimation unit 30, the feature design unit 40, the feature generating unit 50, the model design unit 60, and the prediction unit 70 are implemented by a central processing unit (CPU) of a computer that operates in accordance with a program (automatic prediction program). For example, the program may be stored in the storage unit 80, and the CPU may read the program and may operate, in accordance with the program, as the input unit 10, the selection unit 20, the relationship estimation unit 30, the feature design unit 40, the feature generating unit 50, the model design unit 60, and the prediction unit 70.

In addition, the input unit 10, the selection unit 20, the relationship estimation unit 30, the feature design unit 40, the feature generating unit 50, the model design unit 60, and the prediction unit 70 may each be implemented by dedicated hardware. Furthermore, the automatic prediction system according to the present invention may include two or more physically separated devices connected with wired or wireless communication.

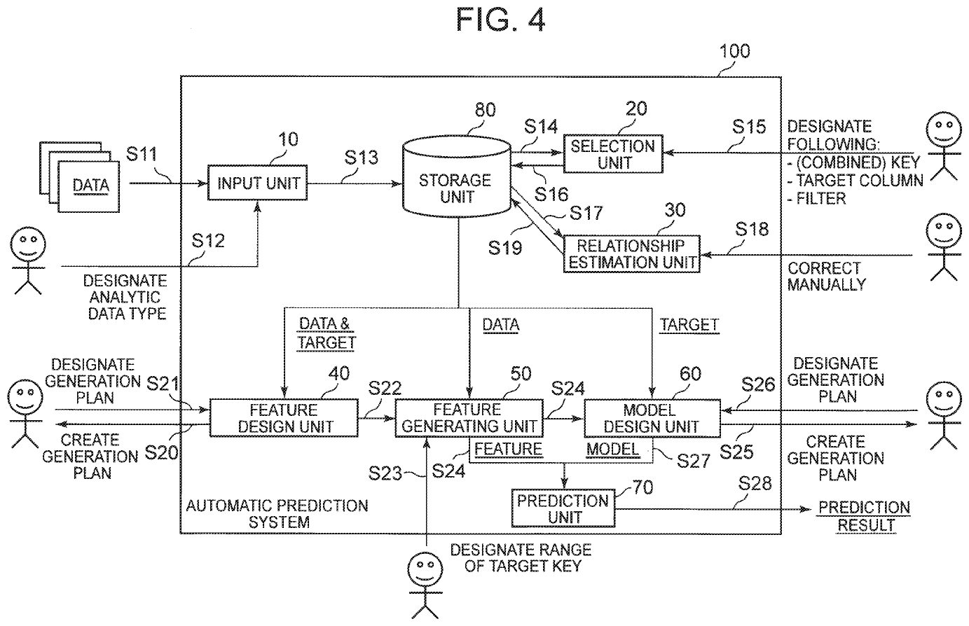

Next, there will be described an exemplary operation of the automatic prediction system of the present exemplary embodiment. FIG. 4 depicts an explanatory diagram of an exemplary operation of the automatic prediction system of the present exemplary embodiment. First, the input unit 10 accepts input of relational data (step S11). In addition, the input unit 10 may accept designation of an analytic data type from the user (step S12). The input unit 10 stores the accepted relational data and the designated type into the storage unit 80 (step S13).

The selection unit 20 creates a target table from the registered relational data. Specifically, the selection unit 20 reads the relational data from the storage unit 80 (step S14). The selection unit 20 presents the read relational data to the user, and accepts designation of a key of the target table, designation of a column to be predicted, and a filter condition for sampling (step S15). The selection unit 20 stores such designation accepted from the user into the storage unit 80 (step S16).

The relationship estimation unit 30 reads the relational data stored in the storage unit 80 and estimates a relationship between columns of different tables (step S17). Specifically, the relationship estimation unit 30 estimates what kind of relationship (specifically, relationship of 1:1, N:1, 1:N, and N:N) is present between the columns. The relationship estimation unit 30 may present the estimated result to the user and may accept a correction instruction from the user (step S18). The relationship estimation unit 30 stores the relationship between the columns into the storage unit 80 (step S19).

The feature design unit 40 designs a feature. Specifically, the feature design unit 40 generates a feature descriptor. First, the feature design unit 40 reads the relational data and the target table from the storage unit 80, calculates a search scale corresponding to a generation plan in consideration of the calculation time and the prediction accuracy, and presents the search scale to the user (step S20).

Here, the generation plan is information representing the search scale of the feature generated by using the feature descriptor, and for example, allows the user to select a search scale among several types (fast search, middle search, full search, and the like). The feature design unit 40 accepts designation of the generation plan from the user (step S21). In addition, the feature design unit 40 generates the feature descriptor corresponding to the generation plan and inputs the feature descriptor into the feature generating unit 50 (step S22).

The feature generating unit 50 generates the feature from the feature descriptor and the relational data that is stored in the storage unit 80. The feature generating unit 50 inputs the generated feature into the model design unit 60 and the prediction unit 70 (step S24). Note that, in generation of the feature, the feature generating unit 50 may accept designation of a range of a target key from the user (step S23).

The model design unit 60 creates the generation plan indicating a scale for generating a prediction model and presents the generation plan to the user (step S25). Here, the model design unit 60 determines, in accordance with the generation plan, the types of algorithms to be used for generating the model and the types of parameters to be used in the algorithms (step S26). The model design unit 60 generates the prediction model, on the basis of the algorithms and parameters of the designated generation plan, and inputs the generated prediction model into the prediction unit 70 (step S27).

The prediction unit 70 performs prediction on the basis of the feature generated by the feature generating unit 50 and the prediction model generated by the model design unit 60, and outputs the prediction result (step S28).

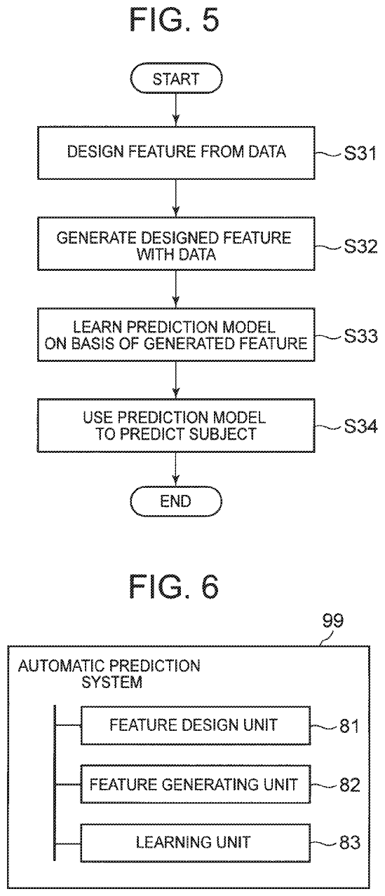

FIG. 5 depicts a flowchart of an exemplary process from automatically designing a feature to performing prediction. The feature design unit 40 designs a feature from data (step S31). Specifically, the feature design unit 40 creates a feature descriptor from relational data, on the basis of each relationship between a designated target (subject to be predicted) and the relational data. The feature generating unit 50 generates the designed feature with the data (step S32). The model design unit 60 learns a prediction model, on the basis of the generated feature (step S33). Then, the prediction unit 70 uses the prediction model to predict the subject indicated by an objective variable (step S34).

As described above, in the present exemplary embodiment, the feature design unit 40 designs the feature, and the feature generating unit 50 generates the designed feature, from the relational data. Then, the learning unit 60 learns the prediction model, on the basis of the generated feature. Therefore, there can be automatically generated a prediction model with which a desired subject is predicted from existing data, without explicitly designating a feature to be used for prediction.

That is, the automatic prediction system according to the present exemplary embodiment makes it possible to perform a process through final prediction only with designation of a target (subject to be predicted) and a relationship by the user.

Next, the overview of the present invention will be described. FIG. 6 depicts a block diagram of the overview of the automatic prediction system according to the present invention. An automatic prediction system 99 according to the present invention includes: a feature design unit 81 (e.g., the feature design unit 40) that designs, from relational data, a feature as a variable likely to affect an objective variable; a feature generating unit 82 (e.g., the feature generating unit 50) that generates the designed feature, from the relational data; and a learning unit 83 (e.g., the model design unit 60) that learns a prediction model, on the basis of the generated feature.

With such a configuration, there can be automatically generated a prediction model with which a desired subject is predicted from existing data, without explicitly designating a feature to be used for prediction.

Specifically, the feature design unit 81 may specify, from a table representing the relational data, a first table (e.g., a target table) including an objective variable and a second table (e.g., a source table) different from the first table, and may create a feature descriptor for generating a feature from the specified first table and second table. Then, the feature generating unit 82 may apply the relational data to the created feature descriptor, and may generate the feature.

Alternatively, the feature design unit 81 may create a feature descriptor by generating a combination of a correspondence condition element representing a correspondence condition of a row of the first table and a row of the second table and an aggregation method element representing an aggregation method of aggregating data of each column included in the second table for each objective variable.

Furthermore, the feature design unit 81 may create a feature descriptor by generating a combination of an extraction condition element including a conditional expression representing an extraction condition of a row included in the second table, the correspondence condition element representing the correspondence condition of the row of the first table and the row of the second table, and the aggregation method element representing the aggregation method of aggregating the data of each column included in the second table for each objective variable.

In addition, the automatic prediction system may include a selection unit (e.g., the selection unit 20) that accepts, from the relational data, designation of a table including an objective variable, a column regarded as the objective variable and a key column as a column of an aggregation unit to be a subject for an aggregation method element in the table.

Furthermore, the automatic prediction system may include a prediction unit (e.g., the prediction unit 70) that uses a prediction model to predict a subject indicated by the objective variable.

The present invention has been described with reference to the exemplary embodiment and examples; however, the present invention is not limited to the above-described exemplary embodiment and examples. Various changes that can be understood by those skilled in the art within the scope of the present invention can be made to the configuration and details of the present invention.

This application is based upon and claims the benefit of priority from Japanese Patent Application No. 2016-212516, filed on Oct. 31, 2016, the entire disclosure of which is incorporated herein.

### REFERENCE SIGNS LIST

10 Input unit
20 Selection unit
30 Relationship estimation unit
40 Feature design unit
50 Feature generating unit
60 Model design unit
70 Prediction unit
80 Storage unit
100 Automatic prediction system

1. An automatic prediction system comprising:
a hardware including a processor;
a feature design unit, implemented by the processor, configured to design, from relational data, a feature as a variable likely to affect an objective variable;
a feature generating unit, implemented by the processor, configured to generate the designed feature, from the relational data; and
a learning unit, implemented by the processor, configured to learn a prediction model, based on the generated feature.

2. The automatic prediction system according to claim 1,
wherein the feature design unit specifies, from a table representing the relational data, a first table including the objective variable and a second table different from the first table, and creates a feature descriptor for generating the feature from the first table and the second table that have been specified, and
the feature generating unit applies the relational data to the created feature descriptor to generate the feature.

3. The automatic prediction system according to claim 2,
wherein the feature design unit creates a feature descriptor by generating a combination of a correspondence condition element representing a correspondence condition of a row of the first table and a row of the second table and an aggregation method element representing an aggregation method of aggregating data of each column included in the second table for each objective variable.

4. The automatic prediction system according to claim 2,
wherein the feature design unit creates a feature descriptor by generating of a combination of an extraction condition element including a conditional expression representing an extraction condition of a row included in the second table, a correspondence condition element representing a correspondence condition of a row of the first table and a row of the second table, and an aggregation method element representing an aggregation method of aggregating data of each column included in the second table for each objective variable.

5. The automatic prediction system according to claim 3, further comprising:
a selection unit, implemented by the processor, configured to accept, from the relational data, designation of a table including an objective variable, and a column regarded as the objective variable and a key column as a column of an aggregation unit to be a subject for the aggregation method element in the table.

6. The automatic prediction system according to claim 1, further comprising:
a prediction unit, implemented by the processor, configured to use the prediction model to predict a subject indicated by the objective variable.

7. An automatic prediction method comprising:
designing, from relational data, a feature as a variable likely to affect an objective variable;
generating the designed feature from the relational data; and
learning a prediction model, on the basis of the generated feature.

8. The automatic prediction method according to claim 7, further comprising:
specifying, from a table representing the relational data, a first table including the objective variable and a second table different from the first table;
creating a feature descriptor for generating the feature from the first table and the second table that have been specified; and
applying the relational data to the created feature descriptor to generate the feature.

9. A non-transitory computer readable information recording medium storing an automatic prediction program, when executed by a processor, that performs a method for:
designing, from relational data, a feature as a variable likely to affect an objective variable;
generating the designed feature, from the relational data; and
learning a prediction model, based on the generated feature.

10. The non-transitory computer readable information recording medium according to claim 9, the method further comprising:
specifying, from a table representing the relational data, a first table including the objective variable and a second table different from the first table;
creating a feature descriptor for generating the feature from the first table and the second table that have been specified; and
applying the relational data to the created feature descriptor to generate the feature.
